(19) United States
(12) Patent Application Publication
(10) Pub. No.: US 2002/0093736 A1
(43) Pub. Date: Jul. 18, 2002

(54) ILLUMINATING DEVICE AND PROJECTING DISPLAY DEVICE

(76) Inventors: YUICHIRO ORI, MORIYAMA-SHI (JP); YASUMASA SAWAI, YAMATOTAKADA-SHI (JP)

Correspondence Address: SIDLEY AUSTIN BROWN & WOOD LLP, 717 NORTH HARWOOD, SUITE 3400, DALLAS, TX, 75201, US

(21) Appl. No.: 09/544,082

(22) Filed: Apr. 6, 2000

(30) Foreign Application Priority Data
Apr. 7, 1999 (JP) 11-099557

(51) Int. Cl. G02B 5/30

(52) U.S. Cl. 359/487

(57) ABSTRACT

An illuminating optical device has a light source that emits non-polarized light; a parallelization converter that converts the light emitted from the light source into essentially parallel light rays; a first lens array that comprises multiple lenses that converge the light rays that strike each of them from the parallelization converter; a polarized light separating element having the configuration of a thin plate with flat top and bottom surfaces, that reflects a first polarized light component of the non-polarized light and transmits the remaining second polarized component, and is located in the light path of the light from the first lens array such that it is angled relative to the light path; a reflection element that reflects the second polarized light component while maintaining its state of polarization and is located near and essentially parallel to the polarized light separating element, wherein the reflection element reflects the light from the first lens array that passed through the polarized light separating element so that the main light rays pass through the polarized light separating element between the points struck by the light from the first lens array; a linear polarization converter that converts into uniform linearly polarized light the light from the first lens array that was reflected by the polarized light separating element and the light from the reflection element that passed through the polarized light separating element; and a second lens array that comprises multiple lenses and is located near the light convergence points for the first lens array, and that leads the light rays that strike each of the multiple lenses from the polarized light separating element to essentially the entire prescribed illumination area.

### RELATED APPLICATION

This application is based on application No. 11-99557 filed in Japan, the content of which is hereby incorporated by reference.

### FIELD OF THE INVENTION

The present invention pertains to an illuminating device and a projecting display device, and more particularly, to an illuminating device equipped with an optical integrator, that converts all non-polarized light into uniform linearly polarized light and that illuminates the entire illumination area with a uniform brightness, as well as to a projecting display device equipped with such an illuminating device.

### DESCRIPTION OF THE PRIOR ART

Currently marketed projecting display devices display images by modulating light in response to the image and projecting the modulated light onto a screen. A projecting display device of this type is used in order to provide images to a large number of people at the same time. In recent years, such a projecting display device has also been used for a large-screen television receiver. In general, modulation of light is performed by means of a liquid crystal valve, and the device is equipped with an illuminating device to provide projecting light to the liquid crystal valve. It is preferred that the projecting display device display images that are bright and have a uniform brightness. In order to achieve this purpose, it is required that the light from the light source be effectively used for projection and uniformly illuminate the entire liquid crystal valve.

A liquid crystal valve modulates linearly polarized light. Since the light emitted from the light source has no polarization—i.e., it is a combination of a light component polarized clockwise and a light component polarized counterclockwise—it is necessary to convert the light used to illuminate the liquid crystal valve into linearly polarized light. In order to convert the illumination light into linearly polarized light, a polarizing plate is conventionally placed immediately in front of the liquid crystal valve. However, because a polarizing plate only allows half of the non-polarized light to pass through, the problems arise that the light is used inefficiently, and because the remaining half is absorbed by the plate, the temperature of the plate increases, which in turn degrades the performance of the liquid crystal valve.

In addition, in order to lead most of the light emitted from the light source to the liquid crystal valve, a reflector that concentrates the light from the light source is used. However, the intensity distribution of the light reflected by the reflector is not uniform. The intensity decreases toward the peripheral areas of the light, and the intensity in the center is also low because the center area is in the shade of the light source itself. Consequently, even if the illuminating device is equipped with a reflector, the entire liquid crystal valve cannot be illuminated uniformly and the displayed image exhibits uneven brightness.

In order to resolve these problems, as proposed in Japanese Laid-Open Patent Application No. 8-234205, for example, the illuminating device is equipped with a polarization converter that converts the non-polarized light emitted from the light source into uniform linearly polarized light and an optical integrator that splits the light from the light source into multiple light rays and leads each light ray to the entire liquid crystal valve.

The basic construction of the optical system of an illuminating device of this type is shown in FIG. 13. This illuminating device 70 has a light source 71, a reflector 72, an IR/UV cut filter 73, a prism 74 comprising a triangular prism 74a and a wedge-shaped prism 74b, a first lens array 75, and a second lens array 76. A polarized light separating film 77 that separates P-polarized light and S-polarized light based on the angle of polarization is formed between the surfaces of the triangular prism 74a and the wedge-shaped prism 74b where they face each other. A total reflection film 78 is formed on the other surface of the wedge-shaped prism 74b.

The non-polarized light emitted from the light source 71 is converted into essentially parallel light by the reflector 72. After being filtered by the IR/UV cut filter 73 so that only light of visible wavelengths will pass through, the light passes through the triangular prism 74a and strikes the polarized light separating film 77 as non-polarized light. Of this light, the component that is S-polarized relative to the polarized light separating film 77 is reflected by the polarized light separating film 77 while the component that is P-polarized relative to the polarized light separating film 77 passes through the polarized light separating film 77. Consequently, linearly polarized light components having mutually perpendicular planes of polarization are separated.

The linearly polarized light that passes through the polarized light separating film 77 is reflected by the total reflection film 78, strikes the polarized light separating film 77 again as P-polarized light, and passes through it. The linearly polarized light that was reflected by the polarized light separating film 77 and the linearly polarized light that was reflected by the total reflection film 78 both strike the first lens array 75. However, because the polarized light separating film 77 and the total reflection film 78 are not parallel to each other, there is a difference between the two light components in terms of the angle of incidence onto the first lens array 75.

Each lens comprising the first lens array 75 converges the light that strikes it. The second lens array 76 is located near the light convergence points for the first lens array 75, such that an image of the light source 71 is formed on each lens of the second lens array 76. Here, the two linearly polarized light components that strike the first lens array 75 have different angles of incidence, two light source 71 images are formed on each lens of the second lens array 76.

A half-wavelength phase plate 79 is located at the position of each lens comprising the second lens array 76, which is struck by the linearly polarized light reflected by the polarized light separating film 77. The linearly polarized light reflected by the polarized light separating film 77 undergoes 90 degree rotation in the plane of polarization by passing through the half-wavelength phase plate 79, whereupon it becomes a polarized light component identical to the linearly polarized light reflected by the total reflection film 78 and then strikes the second lens array 76. Each lens of the second lens array 76 leads the light of the light source 71 images formed on them to the entire surface of the liquid crystal valve 80 comprising the illumination area.

As described above, in the illuminating device 70, the polarized light components are separated by means of a polarized light separating film 77 formed between the contact surfaces in a prism 74, and the polarized light is then converted by the half-wavelength phase plate 79 such that the non-polarized light emitted from the light source 71 is all made into uniform linearly polarized light. In addition, the entire illumination area is illuminated with uniform brightness due to an integrator comprising a first lens array 75 and a second lens array 76. Consequently, a projecting display device equipped with this illuminating device 70 may display bright images that have uniform brightness.

However, in a conventional illuminating device, the polarized light separating film is formed between contact surfaces in a prism, which is heavy, as described above, and therefore, it is difficult to make the device lightweight. Furthermore, in order to separate the polarized light components based on the angle of polarization, it is necessary to form the polarized light separating film by stacking a number of layers, and in order to form the film, film deposition must be performed many times. Consequently, the polarized light separating film formation process requires a long period of time, which poses an obstacle to improving the efficiency of manufacturing the device. Naturally, there are limitations in reducing the costs of the illuminating device as well as the projecting display device using the illuminating device.

### SUMMARY OF THE INVENTION

The object of the present invention is to provide an improved illuminating device.

Another object of the present invention is to provide a lightweight illuminating device that offers good manufacturing efficiency and is capable of converting all of the non-polarized light emitted from the light source into uniform linearly polarized light and uniformly illuminating the entire object of illumination.

Yet another object of the present invention is to provide a projecting display device using the illuminating device described above.

These and other objects may be attained by an illuminating device comprising a light source that emits non-polarized light; a parallelization converter that converts the light emitted from the light source into essentially parallel light rays; a first lens array that comprises multiple lenses that converge the light rays that strike each of them from the parallelization converter; a polarized light separating element that (i) comprises a thin plate having flat top and bottom surfaces, (ii) reflects a first polarized light component of the non-polarized light and transmits the remaining second polarized component, and (iii) is located in the light path of the light from the first lens array such that it is angled relative to the light path; a reflection element that reflects the second polarized light component while maintaining its state of polarization and is located near and essentially parallel to the polarized light separating element, wherein the reflector reflects the light from the first lens array that passed through the polarized light separating element so that the main light rays pass through the polarized light separating element between the points struck by the light from the first lens array; a linear polarization converter that converts into uniform linearly polarized light the light from the first lens array that was reflected by the polarized light separating element and the light from the reflection element that passed through the polarized light separating element; and a second lens array that comprises multiple lenses and is located near the light convergence points for the first lens array and leads the light rays that strike each of the multiple lenses from the polarized light separating element to essentially the entire prescribed illumination area.

In this illuminating device, a thin plate having flat top and bottom surfaces is used for the polarized light separating element to separate the non-polarized light emitted from the light source into two different polarized light components, and prisms are not used. Therefore, the entire device becomes lightweight.

After being converted into essentially parallel light rays, the light from the light source is separated by the first lens array into converging light rays. The first lens array comprises an integrator together with the second lens array. Each light ray resulting from the splitting of the light by the first lens array is separated by the polarized light separating element into a first polarized light component that is reflected and a second polarized light component that is transmitted. The second polarized light component is reflected by the reflection element and re-strikes the polarized light separating element. The reflection element reflects the second polarized light component without altering it, and the light that re-strikes the polarized light separating element passes through it and strikes the second lens array together with the light reflected by the polarized light separating element.

The reflection element is located near and parallel to the polarized light separating element. The re-striking positions at which the main light rays comprising a second polarized light component strike the polarized light separating element, which were reflected by the reflection element, are between the points struck by the light from the first lens array. In addition, the second lens array is located near the convergence positions for the light from the first lens array. Consequently, the first polarized light component and the second polarized light component progress parallel to each other and strike the second lens array without overlapping.

In other words, the first polarized light component and the second polarized light component comprise separate light rays near the second lens array, and it is therefore easy to convert one polarized light component into the other polarized light component. The linear polarization converter performs this conversion, and where the polarized light component is not linearly polarized, it converts the light component into a linearly polarized light component. Therefore, all of the non-polarized light emitted from the light source is led to the illumination area as uniform linearly polarized light.

Each lens of the second lens array leads the light rays that strike it to the entirety of a common illumination area. While the amount of light that strikes each lens of the second lens array varies depending on the location of the lens, because all of the lenses of the second lens array lead the light rays that strike them to the entire illumination area, any given area of the illumination area receives essentially the same amount of light.

The objects described above are also attained by an illuminating device comprising a light source that emits non-polarized light; a parallelization converter that converts the light emitted from the light source into essentially parallel light rays; a first lens array that comprises multiple lenses that converge the light rays from the parallelization converter that strike them; a polarized light separating element that (i) comprises a thin plate having flat top and bottom surfaces, (ii) reflects a first polarized light component of the non-polarized light and transmits the remaining second polarized component, and (iii) is located in the light path of the light from the first lens array such that it is angled relative to the light path; a reflection element that reflects the second polarized light component and converts it into a first polarized light component and reflects the first polarized light component and converts it into a second polarized light component, and is located near and essentially parallel to the polarized light separating element, wherein the reflector reflects the light from the first lens array that passed through the polarized light separating element so that it strikes the polarized light separating element, and the reflector re-reflects the light reflected by the polarized light separating element so that the main light rays pass through the polarized light separating element between the points struck by the light from the first lens array; a linear polarization converter that converts into uniform linearly polarized light the light from the first lens array that was reflected by the polarized light separating element and the light from the reflection element that passed through the polarized light separating element; and a second lens array that comprises multiple lenses and is located near the light convergence points for the first lens array, and leads the light rays that strike each of the multiple lenses from the polarized light separating element to essentially the entire prescribed illumination area.

This illuminating device has a construction similar to that of the previous illuminating device. The difference from the previous one lies in the reflection element: i.e., where the incident light comprises a second polarized light component, the reflection element converts it into a first polarized light component, and where the incident light comprises a first polarized light component, the reflection element converts it into a second polarized light component, instead of reflecting the second polarized light component unchanged. The second polarized light component that strikes the polarized light separating element from the first lens array and passes through it is reflected by the reflection element while being converted into a first polarized light component. It then strikes the polarized light separating element and is reflected by it. The first polarized light component re-strikes the reflection element and is reflected while being converted into a second polarized light component. It then strikes the polarized light separating element again and passes through it. In other words, in this illuminating device, the reflection element converts the light that passed through the polarized light separating element into light that can pass through the polarized light separating element again by reflecting it twice. The effect on the light that passed through the polarized light separating element is the same as that described above.

The objects described above are also attained by an illuminating device comprising a light source that emits non-polarized light; a parallelization converter that converts the light emitted from the light source into essentially parallel light rays; a polarized light separating element that comprises a thin plate having flat top and bottom surfaces and that reflects a first polarized light component of the non-polarized light and transmits the remaining second polarized component, and is located in the light path of the light from the parallelization converter such that it is angled relative to the light path; a reflection element that reflects the second polarized light component while maintaining its state of polarization, and is located near the polarized light separating element such that the former is slightly angled relative to the latter, wherein the reflector reflects the light from the parallelization converter that passed through the polarized light separating element so that it passes through the polarized light separating element in a non-parallel fashion relative to the light from the parallelization converter that was reflected by the polarized light separating element; a first lens array that comprises multiple lenses that converge the light rays from the polarized light separating element that strike them; a linear polarization converter that converts into uniform linearly polarized light the light from the parallelization converter that was reflected by the polarized light separating element and passed through the first lens array and the light from the reflection element that passed through the polarized light separating element and the first lens array; and a second lens array that comprises multiple lenses and is located near the light convergence points for the first lens array, and leads the light rays that strike each of the multiple lenses from the first lens array to essentially the entire prescribed illumination area.

This illuminating device is also equipped with a polarized light separating element to separate the non-polarized light emitted from the light source into two different polarized light components, which has a thin plate configuration with flat top and bottom surfaces, and is therefore lightweight. After being converted into essentially parallel light rays, the light from the light source is separated by the polarized light separating element into a first polarized light component that is reflected and a second polarized light component that is transmitted. The second polarized light component is then reflected by the reflection element and re-strikes the polarized light separating element. The reflection element reflects the second polarized light component while maintaining its state of polarization, and therefore the light that re-strikes the polarized light separating element passes through it and strikes the first lens array together with the light reflected by the polarized light separating element.

The reflection element is located near the polarized light separating element such that the former is slightly angled relative to the latter. The first polarized light component reflected by the polarized light separating element and the second polarized light component reflected by the reflection element strike the first lens array as light components that progress in slightly different directions but are overlapping for the most part. The first lens array comprises an integrator together with the second lens array, which is located near the light convergence points for the first lens array. The light that strikes the first lens array is split into converging light rays by each lens. Since the first polarized light component and the second polarized light component progress in slightly different directions, the polarized light components that pass through the same lens of the first lens array become separated light rays near the second lens array.

The linear polarization converter converts either the first polarized light component or the second polarized light component separated in this way into the other polarized light component. When the polarized light component is not linearly polarized, it further converts it into a linearly polarized light component. Therefore, all of the non-polarized light emitted from the light source is led to the illumination area as uniform linearly polarized light. Each lens of the second lens array leads the light rays that strike them to the entirety of a common illumination area, whereupon the entire illumination area is uniformly illuminated.

The objects described above are also attained by an illuminating device comprising a light source that emits non-polarized light; a parallelization converter that converts the light emitted from the light source into essentially parallel light rays; a polarized light separating element that (i) comprises a thin plate having flat top and bottom surfaces, (ii) reflects a first polarized light component of the non-polarized light and transmits the remaining second polarized component, and (iii) is located in the light path of the light from the parallelization converter such that it is angled relative to the light path; a first reflection element that reflects the second polarized light component while converting it into a first polarized light component and reflects the light from the parallelization converter that passed through the polarized light separating element such that it strikes and is reflected by the polarized light separating element; a second reflection element that reflects the first polarized light component while converting it into a second polarized light component and reflects the light from the first reflection element that was reflected by the polarized light separating element such that it passes through the polarized light separating element in a non-parallel fashion relative to the light from the parallelization converter that was reflected by the polarized light separating element; a first lens array that comprises multiple lenses that converge the light rays from the polarized light separating element that strike each of them; a linear polarization converter that converts into uniform linearly polarized light the light from the parallelization converter that was reflected by the polarized light separating element and passed through the first lens array, as well as the light from the second reflection element that passed through the polarized light separating element and the first lens array; and a second lens array that comprises multiple lenses, is located near the light convergence points for the first lens array, and leads the light rays that strike each of the multiple lenses from the first lens array to essentially the entire prescribed illumination area.

This illuminating device has a construction similar to that of the previous illuminating device. The difference between them lies in the reflection element: the device has, instead of one reflection element that reflects the second polarized light component without altering it, two reflection elements, one being a first reflection element that reflects the second polarized light component and converts it into a first polarized light component, and the other being a second reflection element that reflects the first polarized light component and converts it into a second polarized light component. Unlike the single reflection element, however, these reflection elements are not necessarily located such that they are near and slightly angled relative to the polarized light separating element.

The second polarized light component that strikes and passes through the polarized light separating element via the parallelization converter is reflected by the first reflection element while being converted into a first polarized light component, and it re-strikes and is reflected by the polarized light separating element. This first polarized light component strikes and is reflected by the second reflection element while being converted into a second polarized light component. It again strikes and passes through the polarized light separating element. This second polarized light component and the first polarized light component that was reflected by the polarized light separating element are not parallel to each other, and the angle between the light paths of the two polarized light components is determined by the angles of the first reflection element and the second reflection element relative to the polarized light separating element. The effect on the light that passes through the polarized light element is the same as that described above.

For the polarized light separating element of each of the illuminating devices described above, any element may be used so long as it (i) separates the light into two different polarized light components that may be subsequently converted into uniform linearly polarized light by the linear polarization converter, and (ii) can sufficiently separate these different polarized light components even if the entire element has the configuration of a thin plate.

For example, a cholesteric liquid crystal element may be used for the polarized light separating element. Cholesteric liquid crystal selectively reflects circularly polarized light based on Bragg reflection. It reflects one and transmits the other of the two circularly polarized light components, which have opposite directions of rotation and are contained in non-polarized light. In addition, when it is constructed as a thin plate, it can operate without compromising its characteristic function.

The circularly polarized light that passes through the cholesteric liquid crystal element may be reflected by another cholesteric liquid crystal element designed to have a chilarity opposite that of the first liquid crystal element, while the direction of spin is maintained. It is also possible to reflect the circularly polarized light while reversing the direction of spin by means of a total reflection element such as a regular total reflection mirror. Therefore, a reflection element to reflect the second polarized light component that passes through the polarized light separating element may also be easily selected.

When a cholesteric liquid crystal element is used for the polarized light separating element, the linear polarization converter may comprise a quarter-wavelength phase plate and half-wavelength phase plates. The first polarized light component and the second polarized light component, which have opposite directions of spin, may be converted into linearly polarized light components having mutually perpendicular planes of polarization when passing through the quarter-wavelength phase plate. By having one of the linearly polarized light components pass through a half-wavelength phase plate, its plane of polarization is rotated 90 degrees, such that both linearly polarized light components may become uniform linearly polarized light.

A volume hologram element may also be used for the polarized light separating element. A volume hologram element totally reflects the polarized light component that oscillates in a prescribed direction based on Bragg reflection and transmits the polarized light component that oscillates perpendicular to the former direction of oscillation. It therefore separates the non-polarized light into two linearly polarized light components having mutually perpendicular planes of polarization. In other words, a volume hologram element separates two differently polarized light components based on interference. Its characteristic is not compromised when it is formed in the configuration of a thin plate, and it is not necessary to make the film multi-layered, as in the case of an element that performs separation based on the angle of polarization.

Where a volume hologram element is used for the polarized light separating element, the linear polarization converter may comprise half-wavelength phase plates. The first polarized light component and the second polarized light component separated by the volume hologram element comprise linearly polarized light components having mutually perpendicular planes of polarization. By having one of them pass through a half-wavelength phase plate, both components may be converted into uniform linearly polarized light.

A cholesteric liquid crystal element and volume hologram element do not suffer from a substantial reduction in separation performance, such as that experienced by a polarized light separating element that separates the two polarized light components based on the angle of polarization, even if the angle of incidence slightly changes. Therefore, good separation performance may be obtained without precisely specifying the angle of incidence of the light that strikes the element.

In addition, if a projecting display device is constructed using (i) one of the illuminating devices described above, (ii) a liquid crystal valve that has essentially the same size as the illumination area of the illuminating device and is located in the illumination area to modulate the light from the illuminating device, (iii) a polarizing plate that is located in the light path of the light modulated by the liquid crystal valve, and (iv) a projecting optical system that projects the light that passes through the polarizing plate and causes it to form an image, a display device that provides bright images without unevenness in brightness may be obtained based on the following features of the illuminating device: (1) all of the non-polarized light from the light source is converted into uniform linearly polarized light, and (2) the entire illumination area is uniformly illuminated by the linearly polarized light.

### BRIEF DESCRIPTION OF THE DRAWINGS

This and other objects and features of this invention will become clear from the following description, taken in conjunction with the preferred embodiments with reference to the accompanied drawings in which:

FIG. 1 shows the basic construction of the optical system of the illuminating device comprising a first embodiment.

FIG. 2 shows the basic construction of the optical system of the illuminating device comprising a second embodiment.

FIG. 3 shows the basic construction of the optical system of the illuminating device comprising a third embodiment.

FIG. 4 shows the basic construction of the optical system of the illuminating device comprising a fourth embodiment.

FIG. 5 shows the basic construction of the optical system of the illuminating device comprising a fifth embodiment.

FIG. 6 shows the basic construction of the optical system of the illuminating device comprising a sixth embodiment.

FIG. 7 shows the basic construction of the optical system of the illuminating device comprising a seventh embodiment.

FIG. 8 shows the basic construction of the optical system of the illuminating device comprising an eighth embodiment.

FIG. 9 shows the basic construction of the optical system of the illuminating device comprising a ninth embodiment.

FIG. 10 shows the basic construction of the optical system of the illuminating device comprising a tenth embodiment.

FIG. 11 shows the basic construction of the optical system of the projecting display device comprising an eleventh embodiment.

FIG. 12 is a simplified cross-sectional view of the cholesteric liquid crystal element mounted in the illuminating devices comprising the first and other embodiments.

FIG. 13 shows the basic construction of the optical system of the conventional illuminating device.

### DESCRIPTION OF THE PREFERRED EMBODIMENTS

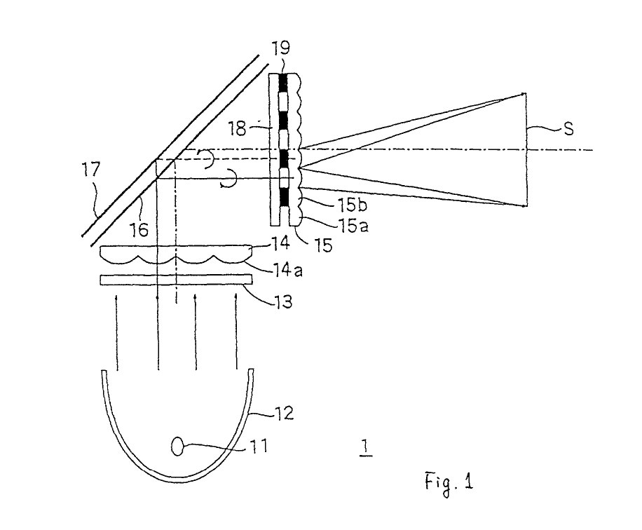

The embodiments of the illuminating device and projecting display device of the present invention are explained below with reference to the drawings. FIG. 1 shows the basic construction of the optical system of the illuminating device 1 comprising a first embodiment. The illuminating device 1 has a light source 11, a reflector 12, an IR/UV cut filter 13, a first lens array 14, a second lens array 15, a first cholesteric liquid crystal element 16, a second cholesteric liquid crystal element 17, a quarter-wavelength phase plate 18 and half-wavelength phase plates 19.

The light source 11 emits light of wavelengths throughout the visible light range. It is preferred that the light source 11 have an essentially even intensity distribution throughout the visible light range and emit a large amount of light. A metal halide lamp or xenon lamp may be preferably used, for example. The light emitted from the light source 11 is non-polarized light in which polarized light having a clockwise spin and polarized light having a counterclockwise spin co-exist.

The reflector 12 reflects and converges the non-oriented light emitted from the light source 11. The reflection surface of the reflector 12 comprises a parabolic surface, and the light source 11 is located in the focal point of the parabolic surface. Therefore, the light emitted from the light source 11 and reflected by the reflector 12 becomes parallel light rays. It is also acceptable if, in place of the reflector 12, the reflecting surface of which comprises a parabolic surface, a different reflector is used together with a condenser lens that converts the reflected light into parallel light rays.

The IR/UV cut filter 13 blocks the light in the infrared light range and the ultraviolet light range, such that only light in the visible light range is allowed to pass through.

The first lens array 14 and the second lens array 15 comprise an optical integrator. The first lens array 14 comprises multiple lenses 14a aligned in a two-dimensional fashion, and is located in the light path of the light from the reflector 12 that passes through the IR/UV cut filter 13. The first lens array 14 is designed such that the optical axis of the reflector 12 passes through the center of the lens array and the lens array is perpendicular to said optical axis. The light from the reflector 12 that strikes the first lens array 14 is split by the lenses 14a into the same number of light rays as the number of lenses 14a, and each light ray resulting from the split comprises converging light.

The first cholesteric liquid crystal element 16 has a thin plate configuration with flat top and bottom surfaces and is located in the light path of the light from the reflector 12 that passed through the first lens array 14 such that it is angled at a 45 degree angle relative to the optical axis of the reflector 12. The cholesteric liquid crystal element 16 is designed such that it reflects circularly polarized light having a clockwise spin and transmits circularly polarized light having a counterclockwise spin. The non-polarized light that strikes the cholesteric liquid crystal element 16 is separated into reflected light comprising circularly polarized light having a clockwise spin and transmitted light comprising circularly polarized light having a counterclockwise spin.

The light that passes through the first cholesteric liquid crystal element 16 strikes the second cholesteric liquid crystal element 17. The cholesteric liquid crystal element 17 also has a thin plate configuration, but is designed to have the opposite chilarity from that of the cholesteric liquid crystal element 16. It therefore reflects circularly polarized light having a counterclockwise spin and transmits circularly polarized light having a clockwise spin. Because the light that passes through the cholesteric liquid crystal element 16 is circularly polarized light having a counterclockwise spin, it is totally reflected by the cholesteric liquid crystal element 17. The light reflected by the cholesteric liquid crystal element 17 remains circularly polarized light having a counterclockwise spin due to the characteristics of the cholesteric liquid crystal.

The cholesteric liquid crystal element 17 is located near and parallel to the cholesteric liquid crystal element 16. Therefore, the light reflected by the cholesteric liquid crystal element 17 re-strikes and passes through the cholesteric liquid crystal element 16. The light path of this light is parallel to the light path of the light reflected by the cholesteric liquid crystal element 16.

The distance between the two cholesteric liquid crystal elements 16 and 17 is specified to be around ½_{—}2 of the alignment interval between lenses 14a of the first lens array 14. Therefore, the point on the cholesteric liquid crystal element 16 struck again by the main light rays of the light reflected by the cholesteric liquid crystal element 17 is in the middle of the points on the cholesteric liquid crystal element 16 that the light rays from each lens 14a of the lens array 14 strike. Consequently, the light paths of the light reflected by the cholesteric liquid crystal elements 16 and 17, respectively, alternate at essentially equal intervals.

The second lens array 15 is located in the light path of the light from the first lens array 14 that was reflected by the cholesteric liquid crystal element 16. The lens array 15 is designed such that the optical axis of the reflector 12, which is bent by the cholesteric liquid crystal element 16, passes through its center, and the lens array 15 is perpendicular to said optical axis. The length of the light path from the lens array 14 to the lens array 15 via the cholesteric liquid crystal element 16 is designed to be essentially the same as the focal length of each lens 14a of the lens array 14, such that the second lens array 15 is located near the light convergence points for the first lens array 14.

The lens array 15 comprises lenses 15a and 15b, which are half the size of the lenses 14a of the lens array 14, and are aligned in a two-dimensional fashion. A pair of adjacent lenses 15a and 15b correspond to one lens 14a of the lens array 14. The light rays that are converted to converging light by each lens 14a of the lens array 14 converge near the lens array 15 and form a dot image of the light source 11 on the corresponding lens. When this occurs, the light from each lens 14a of the lens array 14a is separated by the cholesteric liquid crystal elements 16 and 17 into two light rays, the light paths of which are parallel to each other. The light reflected by the cholesteric liquid crystal element 16 strikes the lens 15a, and the light reflected by the cholesteric liquid crystal element 17 strikes the lens 15b.

A quarter-wavelength phase plate 18 having a size that covers the entire lens array 15 is located on the front surface of the lens array 15. Half-wavelength phase plates 19 are located between the quarter-wavelength phase plate 18 and the lenses 15b struck by the light reflected by the cholesteric liquid crystal element 17.

When passing through the quarter-wavelength phase plate 18, the circularly polarized light having a clockwise spin that was reflected by the cholesteric liquid crystal element 16 and the circularly polarized light having a counterclockwise spin that was reflected by the cholesteric liquid crystal element 17 become linearly polarized light components having mutually perpendicular planes of polarization. The light reflected by the cholesteric liquid crystal element 17 undergoes a 90 degree rotation of the plane of polarization when passing through the half-wavelength phase plate 19, and becomes linearly polarized light having a plane of polarization matching the plane of polarization of the light reflected by the cholesteric liquid crystal element 16. In this way, all of the non-polarized light emitted by the light source 11 is converted into linearly polarized light and strikes the second lens array 15.

The half-wavelength phase plates 19 are located on the front surface of the lens array 15 here, but it is also acceptable if the half-wavelength phase plates 19 are located on the rear surface such that the planes of polarization of the two linearly polarized light components are matched after they pass through the lens array 15. Further, the half-wavelength phase plates 19 are located so as to correspond to the lenses 15b to rotate the plane of polarization of the light reflected by the cholesteric liquid crystal element 17, but it is also acceptable if the half-wavelength phase plates 19 are located such that they correspond to the lenses 15a to rotate the plane of polarization of the light reflected by the cholesteric liquid crystal element 16.

The lenses 15a and 15b of the second lens array 15 are both designed such that they lead the incident light to the entirety of the common illumination area S. Because the intensity distribution of the light that was converted into parallel light rays by the reflector 12 is not uniform, the amount of light striking the first lens array 14 varies from one lens to another, and naturally the amount of light striking the second lens array 15 varies as well. However, by having all lenses 15a and 15b of the second lens array 15 lead the light to the entire illumination area S, rather than each lens 15a and 15b leading the light to a part of the illumination area S, the amount of light received is the same at any point in the illumination area S, so that the entire illumination area S may be uniformly illuminated.

The cholesteric liquid crystal elements 16 and 17 will now be explained in detail. In cholesteric liquid crystal, the molecules are oriented in a helical fashion. Cholesteric liquid crystal selectively reflects circularly polarized light having the same direction of spin as the helical direction and transmits circularly polarized light having a direction of spin opposite to the helical direction. Cholesteric liquid crystal reflects the light in the bandwidth Δλ with the wavelength λ at the center in accordance with Bragg's reflection condition. The bandwidth □λ is essentially expressed by the equation 2.

λ=n·p·cos (θ) 1

Δλ=p•(ne−no) 2

Here, (ne) is the refractive index of the liquid crystal to abnormal light, (no) is the refractive index to normal light, (n) is the average refractive index (average between (ne) and (no)), (p) is the helical pitch of the liquid crystal molecules, and (θ) is the angle of incidence of the light striking the liquid crystal.

Therefore, while it is difficult to obtain a good reflection characteristic regarding all wavelengths in the visible light range using a single liquid crystal layer having a constant pitch, a good reflection characteristic may be obtained for the wavelength range between approximately 50 nm and 100 nm.

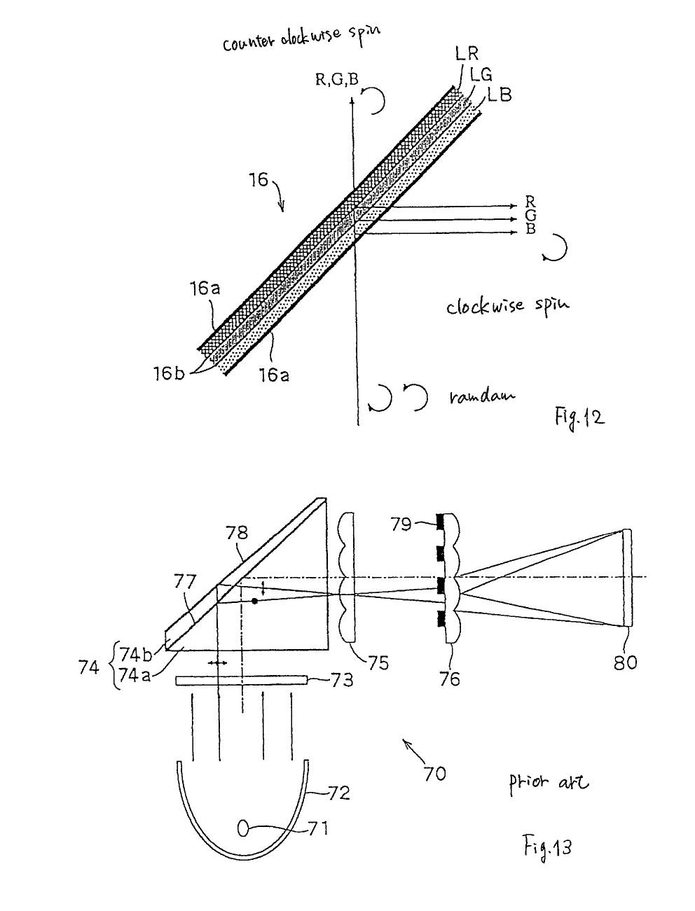

The illuminating device 1 covers the entire visible light range, and in consideration of the characteristics of cholesteric liquid crystal described above, the cholesteric liquid crystal element 16 comprises three layers having different reflection bands. The cross-section of the cholesteric liquid crystal element 16 is shown in a simplified fashion in FIG. 12.

The cholesteric liquid crystal element 16 comprises a layer LB that reflects blue (B) light, a layer LG that reflects green (G) light, and a layer LR that reflects red (R) light, which are sandwiched between two transparent glass substrates 16a. The layers LB, LG and LR are partitioned by viscous layers 16b that scatter a minimal amount of light. The thickness of the layers LB, LG or LR should take into consideration the characteristics of the liquid crystal material, the reflection band, the angle of incidence and the conditions of manufacturing, but should preferably be between several microns and several tens of microns.

Among the non-polarized light that strikes the cholesteric liquid crystal element 16, B light, G light and R light having a clockwise spin are reflected by the layers LB, LG and LR, respectively, and only B light, G light and R light having a counterclockwise spin passes through. Since the layers LB, LG and LR are thin, as described above, the B light, G light and R light reflected by the cholesteric liquid crystal element 16 do not separate, nor do the B light, G light and R light that pass through.

The second cholesteric liquid crystal element 17 also comprises three layers, each of which reflects B light, G light and R light, respectively. However, as described above, the chirality of the cholesteric liquid crystal element 17 is designed to be the opposite of that of the cholesteric liquid crystal element 16.

For the liquid crystal material to form the layers LB, LG and LR, any material may be used so long its helical pitch can be controlled. In particular, a material that attains the desired pitch when heated to a prescribed temperature and that is fixed to that pitch when rapidly cooled or hardened by means of ultraviolet light is preferred, due to its ease of use.

Furthermore, the cholesteric liquid crystal elements 16 and 17 each comprise three layers here, but the number of liquid crystal layers is not limited to this. For example, it is also acceptable to construct the element with a total of six layers, where two layers having slightly different reflection bands perform selective reflection regarding each wavelength range, i.e., B light, G light or R light. Alternatively, if the helical pitch of the molecules is varied within the layer so that the reflection band of that layer is large, two layers or a single layer may handle the entire visible light range.

The light that does not fall within the reflection bands of the cholesteric liquid crystal elements 16 or 17 is not led to the illumination area S because it passes through both cholesteric liquid crystal elements. Therefore, the illuminating device 1 may provide high-quality light that does not include unnecessary components that may give rise to a deterioration in chromatic purity or generate heat.

The chirality of the cholesteric liquid crystal element 16 may be reversed such that it reflects circularly polarized light having a counterclockwise spin and transmits circularly polarized light having a clockwise spin. In that case, the chirality of the cholesteric liquid crystal element 17 should be reversed such that it reflects circularly polarized light having a clockwise spin. Incidentally, it is preferred that the cholesteric liquid crystal elements 16 and 17 be fixed together with spacers having an appropriate thickness from the viewpoint of the alignment interval of the lenses 14a of the lens array 14, so that the cholesteric liquid crystal elements form an integrated unit. This eliminates the need to adjust the distance between the cholesteric liquid crystal elements 16 and 17 during assembly, making manufacturing of the device easy.

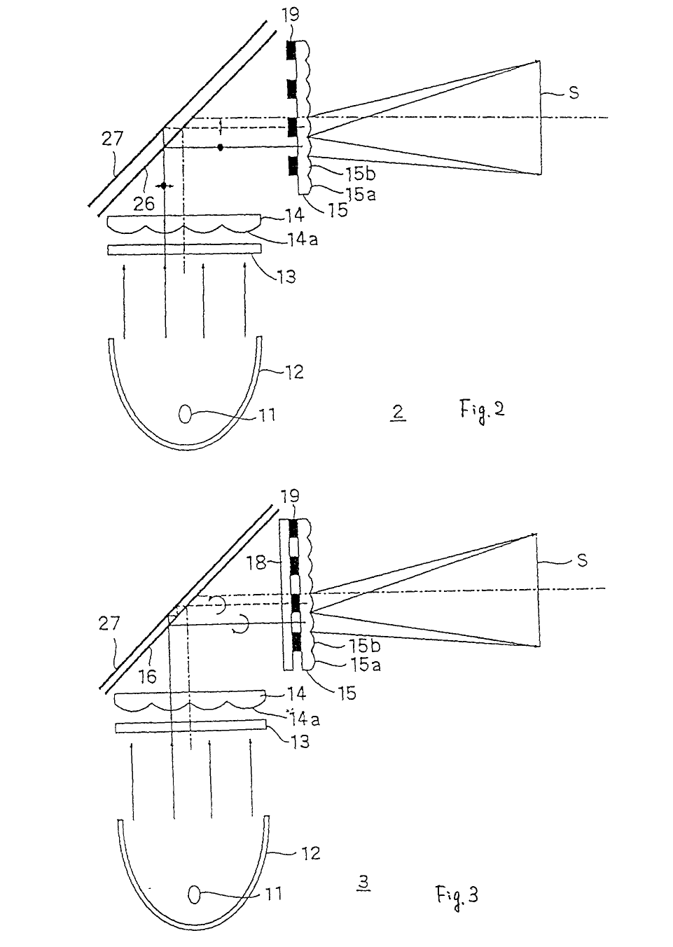

FIG. 2 shows the basic construction of the optical system of the illuminating device 2 comprising a second embodiment. This illuminating device 2 has a volume hologram element 26 and a total reflection element 27 in place of the cholesteric liquid crystal element 16 and the cholesteric liquid crystal element 17 of the illuminating device 1, respectively. The quarter-wavelength phase plate 18 is eliminated. The other components are identical to those used in the illuminating device 1. The same numbers are used for components that have already been described, so further explanation will be omitted.

The volume hologram element 26 and total reflection element 27 have a thin plate configuration, and are located in the same manner as in the cholesteric liquid crystal elements 16 and 17, respectively. In other words, the volume hologram 26 is located in the light path of the light from the reflector 12 that passed through the first lens array 14, such that it is angled 45 degrees relative to the optical axis of the reflector 12, and the total reflection element 27 is located parallel to the volume hologram element 26 with a gap of ½_{—}2 of the alignment interval of the lenses 14a of the lens array 14.

The volume hologram element 26 is created, for example, by forming an interference pattern on a layer of a hologram photosensitive material having an approximately 10 μm thickness and placed on a transparent glass plate by means of the two-light-ray interference exposure method. The volume hologram element 26 is designed such that it reflects the polarized light component that has an electric vector that oscillates perpendicularly to the normal line from the point at which the light strikes and the plane of incidence (indicated by solid dots in the drawing), i.e., S-polarized light, and transmits the polarized light component that has an electric vector that oscillates parallel to the normal line and the plane of incidence (indicated by arrows in the drawing), i.e., the P-polarised light. Consequently, the non-polarized light that strikes the volume hologram element 26 is separated into two linearly polarized light components, i.e., S-polarized light and P-polarized light, which have mutually perpendicular planes of polarization.

The reflection of a polarized light component by the volume hologram element takes place in accordance with the rules of Bragg's reflection, and the reflection characteristic of the element depends on the wavelength of the light. Here, the volume hologram element 26 comprises three hologram layers, each of which reflects B light, G light or R light, in the same manner as the cholesteric liquid crystal element 16 of the illuminating device 1.

The light that passes through the volume hologram element 26 is reflected by the total reflection element 27 while maintaining its state of polarization. The light reflected by the total reflection element 27 re-strikes the volume hologram element 26 as P-polarized light, passes through it and progresses in a light path parallel to that of the light reflected by the volume hologram element 26. The light reflected by the volume hologram element 26 directly strikes the lenses 15a of the second lens array 15, while the light reflected by the total reflection element 27 passes through the half-wavelength phase plates 19 and then strikes the lenses 15b of the second lens array 15. The two linearly polarized light components having mutually perpendicular planes of polarization become uniform linearly polarized light components after one of them passes through the half-wavelength phase plates 19 and undergoes 90 degree rotation of the plane of polarization.

The light that strikes the lens array 15 as uniform linearly polarized light and forms images of the light source 11 on it is led to the entire illumination area S by the lenses 15a and 15b, whereupon the light uniformly illuminates the illumination area S. For the total reflection element 27, a metal surface or total reflection film may be used, for example. These reflect linearly polarized light without changing the state of polarization.

FIG. 3 shows the basic construction of the optical system of the illuminating device 3 comprising a third embodiment. This illuminating device 3 has a total reflection element 27 in place of the second cholesteric liquid crystal element 17 of the illuminating device 1 comprising the first embodiment. The total reflection element 27 is located parallel to the cholesteric liquid crystal element 16, and the distance between the cholesteric liquid crystal element 16 and the total reflection element 27 is specified to be half of the distance between the cholesteric liquid crystal elements 16 and 17 of the illuminating device 1.

The circularly polarized light having a counterclockwise spin that passes through the cholesteric liquid crystal element 16 is reflected by the total reflection element 27, and re-strikes the cholesteric liquid crystal element 16. The total reflection element 27 does not change the state of polarization of linearly polarized light, but reverses the direction of spin of circularly polarized light. Consequently, the light that re-strikes the liquid crystal element 16 is now circularly polarized light having a clockwise spin, and therefore is reflected. The light reflected by the cholesteric liquid crystal element 16 in this way is reflected by the total reflection element 27 again, whereupon it becomes circularly polarized light having a counterclockwise spin, and strikes the cholesteric liquid crystal element 16 once more. This light passes through the cholesteric liquid crystal element 16 and progresses in a light path that is parallel to the light from the lens array 14 that was reflected by the cholesteric liquid crystal element 16.

Here, because the distance between the cholesteric liquid crystal element 16 and the total reflection element 27 is specified as described above, the main rays of the circularly polarized light having a counterclockwise spin that strikes the cholesteric liquid crystal element 16 from the total reflection element 27 become positioned in the middle between the light rays that strike the cholesteric liquid crystal element 16 from each lens 14a of the lens array 14. Therefore, the state of the light that has traveled via the cholesteric liquid crystal element 16 and the total reflection element 27 becomes exactly the same as the state of the light that has traveled via the cholesteric liquid crystal elements 16 and 17 of the illuminating device 1.

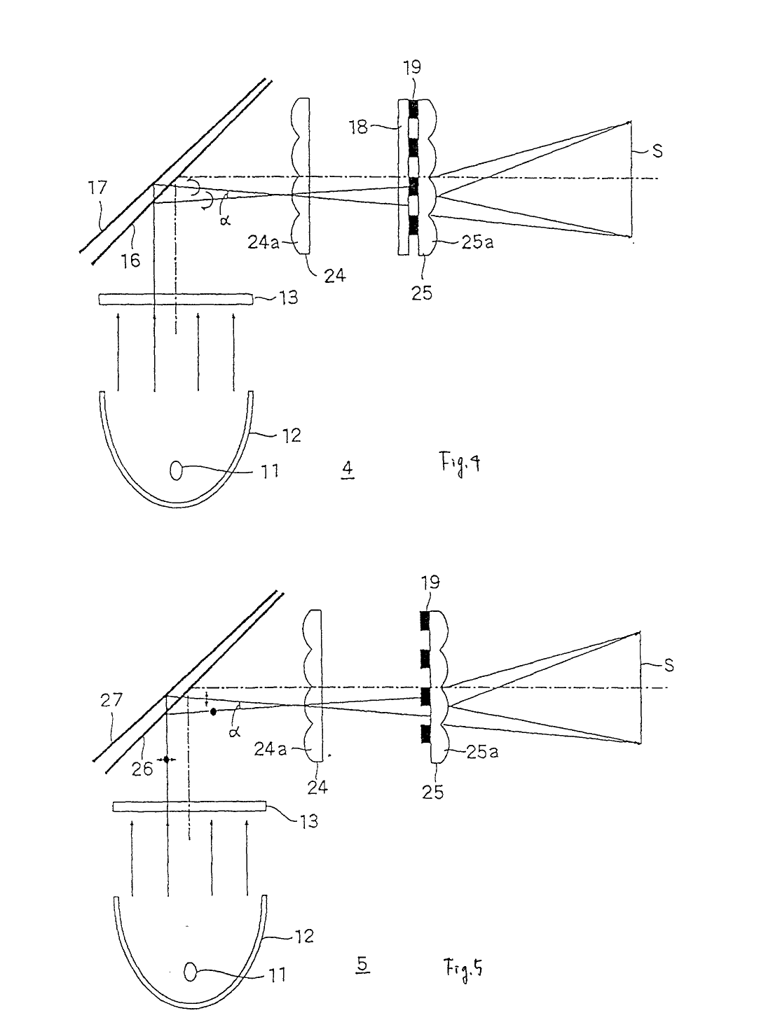

FIG. 4 shows the basic construction of the optical system of the illuminating device 4 comprising a fourth embodiment. This illuminating device 4 has a lens array 24 and a lens array 25 in place of the first lens array 14 and the second lens array 15, respectively, of the illuminating device 1 comprising the first embodiment. The first and second cholesteric liquid crystal elements 16 and 17 are situated close to each other but are not parallel to each other. They are slightly angled relative to each other. The cholesteric liquid crystal elements 16 and 17 are symmetrically aligned with each other relative to a plane that is angled by 45 degrees relative to the optical axis of the reflector 12.

The lens arrays 24 and 25 comprise an integrator. The number of the lenses 24a of the first lens array 24 and the number of lenses 25a of the second lens array 25 are the same. One lens 24a corresponds to one lens 25a.

The first lens array 24 is located in the light path of the light reflected by the first cholesteric liquid crystal element 16, such that the optical axis of the reflector 12, which is bent by the plane of symmetricity above, passes through the center of the first lens array 24 in a perpendicular fashion. The second lens array 25 is located in the light path of the light from the first cholesteric liquid crystal element 16 that passes through the first lens array 24, such that the bent optical axis of the reflector 12 passes through the center of the second lens array 25 in a perpendicular fashion.

The length of the light path from the lens array 24 to the lens array 25 is specified such that it is essentially equal to the focal length of each lens 24a of the lens array 24. Therefore, the second lens array 25 is located near the converging points for the first lens array 24.

The non-polarized light from the light source 11 strikes the first cholesteric liquid crystal element 16 from the reflector 12 as parallel light rays. This light is separated into circularly polarized light having a clockwise spin that is reflected and circularly polarized light having counterclockwise spin that is transmitted. The transmitted light is then reflected by the cholesteric liquid crystal element 17. The light reflected by the cholesteric liquid crystal element 17 maintains its state of polarization, and it re-strikes and passes through the cholesteric liquid crystal element 16 as circularly polarized light having a counterclockwise spin.

The light from the cholesteric liquid crystal element 17 that passes through the cholesteric liquid crystal element 16 overlaps with the light from the reflector 12 that was reflected by the cholesteric liquid crystal element 16 and strikes the first lens array 24. The light that strikes the lens array 24 is split by each lens 24a, and each light ray resulting from the split is made to converge.

Here, because the cholesteric liquid crystal element 16 and 17 are angled relative to each other, the light path of the light from the cholesteric liquid crystal element 17 that passes through the cholesteric liquid crystal element 16 and the light path of the light from the reflector 12 that was reflected by the cholesteric liquid crystal element 16 do not match each other, and an angle a results between the two light paths. This angle α is twice as large as the angle between the cholesteric liquid crystal element 17 and the cholesteric liquid crystal element 16.

Of the light that strikes each lens 24a of the lens array 24, the light from the cholesteric liquid crystal element 17 that passes through the cholesteric liquid crystal element 16 and the light from the reflector 12 that was reflected by the cholesteric liquid crystal element 16 have different angles of incidence, and therefore are separated near the converging point. In other words, two images of the light source 11 are formed on the same lens 25a of the second lens array 25.

A quarter-wavelength phase plate 18 that covers the entire lens array 25 is located on the front surface of the lens array 25. Half-wavelength phase plates 19 are located between those lenses 25a struck by the light reflected by the cholesteric liquid crystal element 16 and the quarter-wavelength phase plate 18.

The polarized light having a clockwise spin that was reflected by the cholesteric liquid crystal element 16 and the polarized light having a counterclockwise spin that was reflected by the cholesteric liquid crystal element 17 become linearly polarized light components having mutually perpendicular planes of polarization, when passing through the quarter-wavelength phase plate 18. The light reflected by the cholesteric liquid crystal element 16 further undergoes 90 degree rotation of the plane of polarization when passing through the half-wavelength phase plate 19 and becomes linearly polarized light having a plane of polarization that matches that of the light reflected by the cholesteric liquid crystal element 17. All of the non-polarized light emitted from the light source 11 thus strikes the second lens array 25 as uniform linearly polarized light.

It is also acceptable if the half-wavelength phase plates 19 are located on the rear surface of the lens array 25 such that the planes of polarization of the two linearly polarized light components are made to match after they pass through the lens array 25, as described above. In addition, it is also acceptable if the half-wavelength phase plates 19 are located on the lenses 25a that are struck by the light reflected by the cholesteric liquid crystal element 17.

Each lens 25a of the second lens array 25 is designed to lead the incident light to the entire illumination area S. While the amount of light that strikes each lens 25a varies from one lens to another, by having all lenses 25a lead the light to the entire illumination area S, the entire illumination area S may be uniformly illuminated.

In the illuminating device 1 comprising the first embodiment, it was made possible for only one light component to undergo polarization conversion by having the light paths of the separated light components be parallel to each other but not overlap with each other, but in the illuminating device 4 comprising this embodiment, this was made possible by creating an angle between the light paths of the separated light components. In the former construction, the length of the light path from the light source to the second lens array may be made short, while in the latter construction, the number of the lenses of the second lens array and the number of the lenses of the first lens array may be made identical.

In the illuminating device 4 comprising this embodiment, cholesteric liquid crystal elements 16 and 17 are situated such that they are symmetrical relative to a plane that is angled by 45 degrees relative to the optical axis of the reflector 12, but it is also acceptable if one of them is angled by 45 degrees relative to the optical axis of the reflector 12 while the other is angled by a different angle. In this case, the light path of the light from the cholesteric liquid crystal element 17 that passes through the cholesteric liquid crystal element 16 and the light path of the light from the reflector 12 that was reflected by the cholesteric liquid crystal element 16 become slightly asymmetrical relative to the optical axis of each lens 24a of the first lens array 24, and therefore, in order to correct this asymmetricity, each lens 24a of the lens array 24 should be slightly decentered.

FIG. 5 shows the basic construction of the optical system of the illuminating device 5 comprising a fifth embodiment. This illuminating device 5 has a volume hologram element 26 explained above with reference to the second embodiment and a total reflection element 27 in place of the cholesteric liquid crystal element 16 and the cholesteric liquid crystal element 17, respectively, of the illuminating device 4 described above. In addition, the quarter-wavelength phase plate 18 is eliminated. The volume hologram element 26 and the total reflection element 27 are slightly angled relative to each other while being symmetrical relative to a plane that is angled by 45 degrees with respect to the optical axis of the reflector 12. The other components are identical to those used in the illuminating device 4.

In the illuminating device 5, the non-polarized light from the reflector 12 is separated into two linearly polarized light components having mutually perpendicular planes of polarization by the volume hologram element 26, and the light paths of the separated light components are forced by the total reflection element 27 to have an angle α in between them. One of the linearly polarized light components then undergoes 90 degree rotation of the plane of polarization by means of the half-wavelength phase plates 19, so that all of the light led to the illumination area S becomes uniform linearly polarized light.

FIG. 6 shows the basic construction of the optical system of the illuminating device 6 comprising a sixth embodiment. In this illuminating device 6, the angles of the unit comprising the light source 11, reflector 12, IR/UV cut filter 13 and first lens array 14 of the illuminating device comprising the first embodiment and of the unit comprising the second lens array 15, quarter-wavelength phase plate 18 and half-wavelength phase plate 19 to the cholesteric liquid crystal element 16 are changed.

The cholesteric liquid crystal elements 16 and 17 are angled approximately 60 degrees relative to the optical axis of the reflector 12, and therefore the angle of incidence of the light from the first lens array 14 to the cholesteric liquid crystal element 16 is approximately 30 degrees. The second lens array 15 is located such that it is perpendicular to the optical axis of the reflector 12 that is bent by the cholesteric liquid crystal element 16. The distance between the cholesteric liquid crystal elements 16 and 17 is specified to be approximately half of the alignment interval of the lenses 14a of the lens array 14, such that the light paths of the light rays reflected by each of them will be distributed at equal intervals. The rest of the construction is the same as that of the illuminating device 1.

In general, manufacturing of a cholesteric liquid crystal layer is easy if the helical axes of the molecules are oriented along the normal line of the liquid crystal layer. If the helical axes of the molecules are oriented this way, the smaller the angle of incidence, the better the performance of light component separation. Therefore, making the angle of incidence small as in this embodiment contributes to making the manufacturing of the cholesteric liquid crystal element 16 easy, while improving its light component separation performance. Moreover, when the angle of incidence to the cholesteric liquid crystal element 16 is small, the unit comprising the light source 11, reflector 12, filter 13 and first lens array 14 and the unit comprising the second lens array 15, quarter-wavelength phase plate 18 and half-wavelength phase plates 19 become closer together, which contributes to making the illuminating device 6 compact in size.

The value ‘approximately 30 degrees’ indicated in these embodiments is only an example of the angle of incidence to the cholesteric liquid crystal element 16, and a different angle may be specified. Similarly, in the illuminating device 2 comprising the second embodiment that has a volume hologram element 26 and total reflection element 27 in place of the cholesteric liquid crystal elements 16 and 17, respectively, and in the illuminating device 3 comprising the third embodiment that has a total reflection element 27 in place of the cholesteric liquid crystal element 17, the angle of incidence to the volume hologram element 26 or the cholesteric liquid crystal element 16 may be an angle other than 45 degrees.

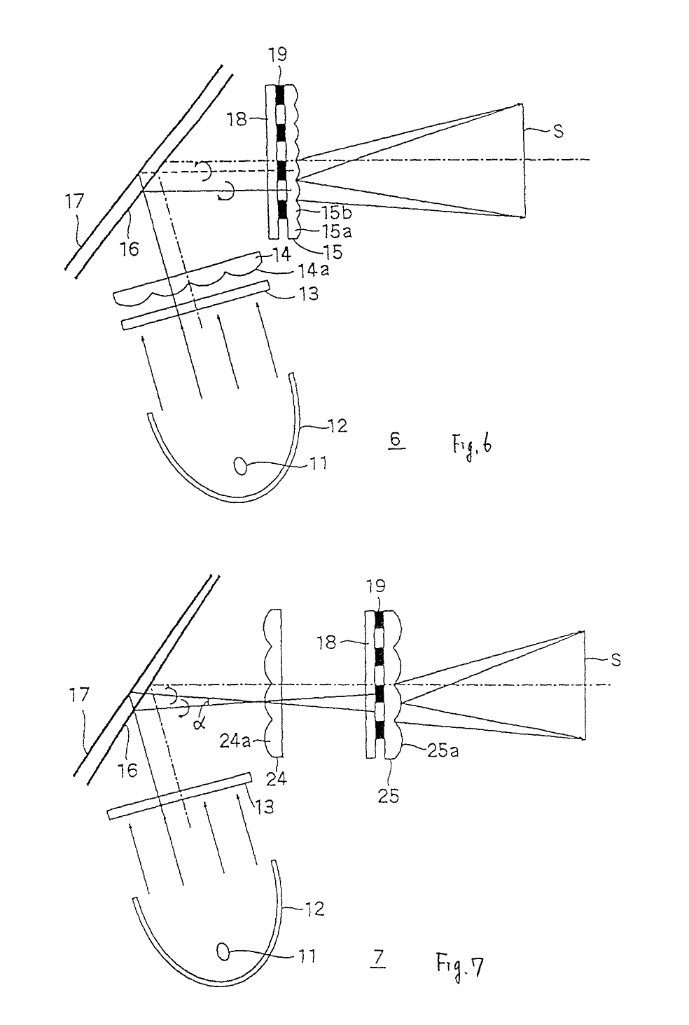

FIG. 7 shows the basic construction of the optical system of the illuminating device 7 comprising a seventh embodiment. In this illuminating device 7, the angles of the unit comprising the light source 11, the reflector 12 and the IR/UV cut filter 13, and the unit comprising the first lens array 24, the second lens array 25, the quarter-wavelength phase plate 18 and the half-wavelength phase plates 19 relative to the cholesteric liquid crystal element 16 are different from those in the illuminating device 4 comprising the fourth embodiment. The angle of incidence of the light from the reflector 12 to the first cholesteric liquid crystal element 16 is designed to be approximately 30 degrees in the illuminating device 7 as well.

Where the light paths of the separated light components are angled to each other by an angle α in this way so that one of them may be selectively converted, it is useful to have the angle of incidence of the light to the cholesteric liquid crystal element 16 be an angle other than 45 degrees. The illuminating device 5 comprising the fifth embodiment that has a volume hologram element 26 and total reflection element 27 in place of the cholesteric liquid crystal elements 16 and 17, respectively, may also have the same construction as well.

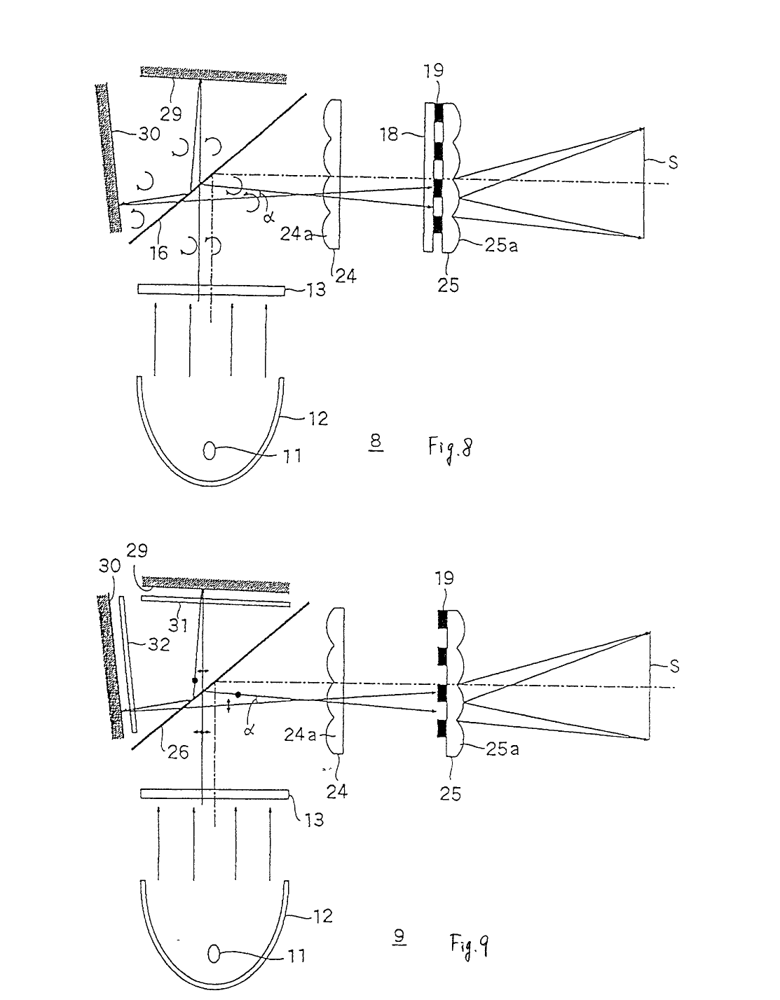

FIG. 8 shows the basic construction of the optical system of the illuminating device 8 comprising an eighth embodiment. This illuminating device 8 has a first total reflection element 29 and a second total reflection element 30 in place of the second cholesteric liquid crystal element 17 of the illuminating device 4 comprising the fourth embodiment.

The first total reflection element 29 is located such that it faces the reflector 12 via the cholesteric liquid crystal 16 while the second total reflection element 30 is located such that it faces the first lens array 24 via the cholesteric liquid crystal element 16. Although the angle between the total reflection element 29 and the total reflection element 30 is close to 90 degrees, it is designed to be other than 90 degrees so that there is an angle α between the light paths of the post-separation light components.

The non-polarized light that strikes the cholesteric liquid crystal element 16 from the reflector 12 is separated into circularly polarized light having a clockwise spin that is reflected, and circularly polarized light having a counterclockwise spin that is transmitted. The light that passes through the cholesteric liquid crystal element 16 is reflected by the total reflection element 29 and becomes circularly polarized light having a clockwise spin. It then re-strikes and is reflected by the cholesteric liquid crystal element 16. This light is reflected by the total reflection element 30 and is converted back into circularly polarized light having a counterclockwise spin. It strikes the cholesteric liquid crystal element 16 again and passes through it.

The effect of the first lens array 24, quarter-wavelength phase plate 18, half-wavelength phase plate 19 and second lens array 25 on the light from the total reflection element 30 that passes through the cholesteric liquid crystal element 16 and the light from the reflector 12 that was reflected by the cholesteric liquid crystal element 16 is the same as described above. All of the non-polarized light emitted from the light source 11 may be made into uniform linearly polarized light, which uniformly illuminates the entire illumination area S in this construction as well.

FIG. 9 shows the basic construction of the optical system of the illuminating device 9 comprising a ninth embodiment. This illuminating device 9 has the two total reflection elements 29 and 30 of the illuminating device 8 above and two quarter-wavelength phase plates 31 and 32 in place of the total reflection element 27 of the illuminating device 5 comprising the fifth embodiment that has a volume hologram element 26. The quarter-wavelength phase plate 31 is located between the volume hologram element 26 and the total reflection element 29 close to the total reflection element 29, while the quarter-wavelength phase plate 32 is located between the volume hologram element 26 and the total reflection element 30 close to the total reflection element 30.

The non-polarized light that strikes the volume hologram element 26 from the reflector 12 is separated into two linearly polarized light components, i.e., S-polarized light that is reflected, and P-polarized light that is transmitted. The light that passes through the volume hologram element 26 is reflected by the total reflection element 29 and re-strikes the volume hologram element 26, and during this process, it passes through the quarter-wavelength phase plate 31 twice and undergoes 90 degree rotation of the plane of polarization. Consequently, when it re-strikes the volume hologram element 26, it is S-polarized relative to the volume hologram element 26, and is therefore reflected.

This light reflected by the volume hologram element 26 is reflected by the total reflection element 30 and re-strikes the volume hologram element 26. During this process, it passes through the quarter-wavelength phase plate 32 twice. Consequently, the light from the total reflection element 30 is again P-polarized light when it strikes the volume hologram element 26 and passes through it.

The effect of the first lens array 24, half-wavelength phase plate 19 and second lens array 25 on the light from the total reflection element 30 that passes through the volume hologram element 26 and the light from the reflector 12 that was reflected by the volume hologram element 26 is the same as described above. The entire illumination area S is uniformly illuminated by the linearly polarized light obtained through conversion of all of the light emitted from the light source 11 in this construction as well.

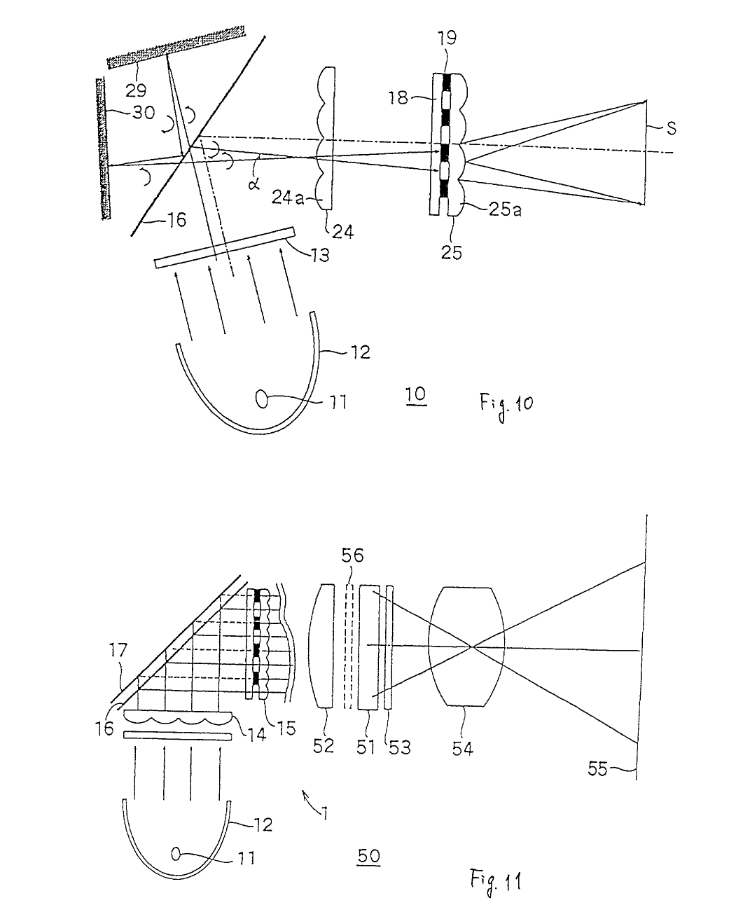

FIG. 10 shows the basic construction of the optical system of the illuminating device 10 comprising a tenth embodiment. In this illuminating device 10, the angles of the unit comprising the light source 11, the reflector 12 and the IR/UV cut filter 13, and the unit comprising the first lens array 24, the second lens array 25, the quarter-wavelength phase plate 18 and the half-wavelength phase plates 19 to the cholesteric liquid crystal element 16 are different from in the illuminating device 8 comprising the eighth embodiment. The effect of each component on the light from the light source 11 is the same as described above, and further explanation will be omitted.

The angle of incidence of the light from the reflector 12 to the cholesteric liquid crystal element 16 is approximately 30 degrees in the illuminating device 10 as well, but as described above, this angle of incidence may be designed to be different. The angle of incidence of the light to the volume hologram element 26 in the illuminating device 9 comprising the ninth embodiment may also be designed to be an angle other than 45 degrees as in the illuminating device 10.

An embodiment of the projecting display device pertaining to the present invention will now be explained. FIG. 11 shows the basic construction of the optical system of the projecting display device 50 comprising an eleventh embodiment. This projecting display device 50 comprises the illuminating device 1 comprising the first embodiment, a transmitting liquid crystal valve 51, a condenser lens 52, a polarizing plate 53, a projection lens 54 and a screen 55. The liquid crystal valve 51 comprises numerous pixels of three types that selectively modulate B light, G light and R light, respectively, and are aligned in a two-dimensional fashion. The modulation of light by each pixel is individually controlled by a control circuit not shown in the drawing in accordance with the signal expressing the image.

The liquid crystal valve 51 has essentially the same size as that of the entire illumination area S of the illuminating device 1 shown in FIG. 1, and is located on or near the illumination area S. The condenser lens 52 is located near the liquid crystal valve 51 such that it causes the light from the second lens array 15 of the illuminating device 1 to strike the liquid crystal valve 51 essentially at a right angle.

The polarizing plate 53 is located on the opposite side of the liquid crystal valve 51 from the illuminating device 1. It transmits one of the mutually perpendicular linearly polarized light components of the light modulated by the liquid crystal valve 51 and blocks the other. Where the image is displayed using the linearly polarized light component that underwent 90 degree rotation of the plane of polarization through modulation by means of the liquid crystal valve 51, the direction of transmission by the polarizing plate 53 is designed to be perpendicular to the path of the linearly polarized light led from the illuminating device 1. Where the image is displayed using the linearly polarized light component that maintained its polarization through the modulation by the liquid crystal valve 51, the direction of transmission by the polarizing plate 53 is specified to be parallel to the path of the linearly polarized light led from the illuminating device 1.

The projection lens 54 projects and causes the light that passes through the polarizing plate 53 to form an image on the screen 55 so that the image expressed by the light is formed on the screen 55. Where the image on the screen 55 is observed from the side of the illuminating device 1, a reflective screen is used for the screen 55. Where the image on the screen 55 is observed from the opposite side from the illuminating device 1, as in the case of a television receiver, a transmitting screen that has a light scattering function is used for the screen 55.

Because the illuminating device 1 leads all of the light emitted from the light source 11 as uniform linearly polarized light to the liquid crystal valve 51, it is not necessary to have a polarizing plate on the front surface of the liquid crystal valve 51. However, a polarizing plate 56 may be inserted between the liquid crystal valve 51 and the condenser lens 52, as indicated by the dotted lines, that transmits the linearly polarized light from the illuminating device 1 only in order to prevent stray light from entering and causing a reduction in contrast.

A projecting display device 50 equipped with the illuminating device 1 was shown here as an example, but the projecting display device may be equipped with any of the illuminating devices 2 through 10 in place of the illuminating device 1. Since any of the illuminating devices makes highly efficient use of light and uniformly illuminates the entire illumination area, bright images without unevenness in brightness may be displayed.

The illuminating device comprising any of the embodiments separates the non-polarized light into two polarized light components and converts one of the post-separation polarized light components so that all of the light becomes uniform linearly polarized light, offering highly efficient use of light. Furthermore, it can uniformly illuminate the entire illumination area by means of an integrator comprising two lens arrays. Moreover, because the polarized light separating element comprises an element having a thin plate configuration instead of a heavy prism, the device is lightweight.

In the construction in which a cholesteric liquid crystal element or a volume hologram element is used for the polarized light separating element, it is not necessary for the element to be multi-layered, which improves the efficiency of manufacturing while reducing its cost.

In addition, the projecting display device of the present invention can provide bright images without unevenness in brightness, and is lightweight and inexpensive.

Although the present invention has been fully described by way of example with reference to the accompanying drawings, it is to be understood that various changes and modifications will be apparent to those skilled in the art. Therefore, unless otherwise such changes and modification depart from the scope of the present invention, they should be construed as being included therein.

What is claimed is:

1. An illuminating optical device comprising:
a light source that emits non-polarized light;
a parallelization converter that converts the light emitted from the light source into essentially parallel rays of light;
a first lens array that has multiple lenses that converge the light rays that strike each of them from the parallelization converter;
a polarized light separating element having the configuration of a thin plate with flat top and bottom surfaces, that reflects a first polarized light component of the non-polarized light and transmits the remaining second polarized component, and is located in the light path of the light from the first lens array such that it is angled relative to the light path;
a reflection element that reflects the second polarized light component while maintaining its state of polarization and is located near and essentially parallel to the polarized light separating element, wherein the reflection element reflects the light from the first lens array that passed through the polarized light separating element, so that the main light rays pass through the polarized light separating element between the points struck by the light from the first lens array;
a linear polarization converter that converts into uniform linearly polarized light the light from the first lens array that was reflected by the polarized light separating element and the light from the reflection element that passed through the polarized light separating element; and
a second lens array that comprises multiple lenses and is located near the light convergence points for the first lens array, and leads the light rays that strike each of the multiple lenses from the polarized light separating element to essentially the entire prescribed illumination area.

2. The illuminating device claimed in claim 1, wherein the polarized light separating element comprises a cholesteric liquid crystal element.

3. The illuminating device claimed in claim 2, wherein the linear polarization converter comprises a quarter-wavelength phase plate and half-wavelength phase plates.

4. The illuminating device claimed in claim 1, wherein the polarized light separating element is a volume hologram element.

5. The illuminating device claimed in claim 4, wherein the linear polarization converter comprises half-wavelength phase plates.

6. An illuminating optical device comprising:
a light source that emits non-polarized light;
a parallelization converter that converts the light emitted from the light source into essentially parallel light rays;
a first lens array that comprises multiple lenses that converge the light rays that strike each of them from the parallelization converter
a polarized light separating element having the configuration of a thin plate with flat top and bottom surfaces, that reflects a first polarized light component of the non-polarized light and transmits the remaining second polarized component, and is located in the light path of the light from the first lens array such that it is angled relative to the light path;
a reflection element that reflects the second polarized light component and the first polarized light component while converting them into a first polarized light component and a second polarized light component, respectively, and is located near and essentially parallel to the polarized light separating element, wherein the reflection element reflects the light from the first lens array that passed through the polarized light separating element so that it strikes the polarized light separating element, and the reflection element re-reflects the light reflected by the polarized light separating element so that the main light rays pass through the polarized light separating element between the points struck by the light from the first lens array;
a linear polarization converter that converts into uniform linearly polarized light the light from the first lens array that was reflected by the polarized light separating element and the light from the reflection element that passed through the polarized light separating element; and
a second lens array that comprises multiple lenses and is located near the light convergence points for the first lens array, and that leads the light rays that strike each of the multiple lenses from the polarized light separating element to essentially the entire prescribed illumination area.

7. The illuminating device claimed in claim 6, wherein the polarized light separating element comprises a cholesteric liquid crystal element.

8. The illuminating device claimed in claim 7, wherein the linear polarization converter comprises a quarter-wavelength phase plate and half-wavelength phase plates.

9. The illuminating device claimed in claim 6, wherein the polarized light separating element is a volume hologram element.

10. The illuminating device claimed in claim 9, wherein the linear polarization converter comprises half-wavelength phase plates.

11. An illuminating optical device comprising:
a light source that emits non-polarized light;
a parallelization converter that converts the light emitted from the light source into essentially parallel light rays;
a polarized light separating element having the configuration of a thin plate with flat top and bottom surfaces, that reflects a first polarized light component of the non-polarized light and transmits the remaining second polarized component, and is located in the light path of the light from the parallelization converter such that it is angled relative to the light path;
a reflection element that reflects the second polarized light component while maintaining its state of polarization and is located near the polarized light separating element such that the former is slightly angled relative to the latter, wherein the reflection element reflects the light from the parallelization converter that passed through the polarized light separating element so that it passes through the polarized light separating element in a non-parallel fashion relative to the light from the parallelization converter that was reflected by the polarized light separating element;
a first lens array that comprises multiple lenses that converge the light rays that strike each of them from the polarized light separating element;
a linear polarization converter that converts into uniform linearly polarized light the light from the parallelization converter that was reflected by the polarized light separating element and passed through the first lens array and the light from the reflection element that passed through the polarized light separating element and the first lens array; and
a second lens array that comprises multiple lenses and is located near the light convergence points for the first lens array, and that leads the light rays that strike each of the multiple lenses from the first lens array to essentially the entire prescribed illumination area.

12. The illuminating device claimed in claim 11, wherein the polarized light separating element comprises a cholesteric liquid crystal element.

13. The illuminating device claimed in claim 12, wherein the linear polarization converter comprises a quarter-wavelength phase plate and half-wavelength phase plates.

14. The illuminating device claimed in claim 11, wherein the polarized light separating element is a volume hologram element.

15. The illuminating device claimed in claim 14, wherein the linear polarization converter comprises half-wavelength phase plates.

16. An illuminating optical device comprising:
a light source that emits non-polarized light;
a parallelization converter that converts the light emitted from the light source into essentially parallel light rays;
a polarized light separating element having the configuration of a thin plate with flat top and bottom surfaces, that reflects a first polarized light component of the non-polarized light and transmits the remaining second polarized component, and is located in the light path of the light from the parallelization converter such that it is angled relative to the light path;
a first reflection element that reflects the second polarized light component while converting it into a first polarized light component, and that reflects the light from the parallelization converter that passed through the polarized light separating element such that it strikes and becomes reflected by the polarized light separating element;
a second reflection element that reflects the first polarized light component while converting it into a second polarized light component and that reflects the light from the first reflection element that was reflected by the polarized light separating element, such that it passes through the polarized light separating element in a non-parallel fashion relative to the light from the parallelization converter that was reflected by the polarized light separating element;
a first lens array that comprises multiple lenses that converge the light rays that strike each of them from the polarized light separating element;
a linear polarization converter that converts into uniform linearly polarized light the light from the parallelization converter that was reflected by the polarized light separating element and passed through the first lens array and the light from the second reflection element that passed through the polarized light separating element and the first lens array; and
a second lens array that comprises multiple lenses and is located near the light convergence points for the first lens array, and that leads the light rays that strike each of the multiple lenses from the first lens array to essentially the entire prescribed illumination area.

17. The illuminating device claimed in claim 16, wherein the polarized light separating element comprises a cholesteric liquid crystal element.

18. The illuminating device claimed in claim 17, wherein the linear polarization converter comprises a quarter-wavelength phase plate and half-wavelength phase plates.

19. The illuminating device claimed in claim 16, wherein the polarized light separating element is a volume hologram element.

20. The illuminating device claimed in claim 19, wherein the linear polarization converter comprises half-wavelength phase plates.

21. A projecting display device comprising:
an illuminating optical device having:
a light source that emits non-polarized light;
a parallelization converter that converts the light emitted from the light source into essentially parallel rays of light;
a first lens array that comprises multiple lenses that converge the light rays that strike each of them from the parallelization converter;
a polarized light separating element having the configuration of a thin plate with flat top and bottom surfaces, that reflects a first polarized light component of the non-polarized light and transmits the remaining second polarized component, and is located in the light path of the light from the first lens array such that it is angled relative to the light path;
a reflection element that reflects the second polarized light component while maintaining its state of polarization and is located near and essentially parallel to the polarized light separating element, wherein the reflection element reflects the light from the first lens array that passed through the polarized light separating element, so that the main light rays pass through the polarized light separating element between the points struck by the light from the first lens array;
a linear polarization converter that converts into uniform linearly polarized light the light from the first lens array that was reflected by the polarized light separating element and the light from the reflection element that passed through the polarized light separating element; and
a second lens array that comprises multiple lenses and is located near the light convergence points for the first lens array, and leads the light rays that strike each of the multiple lenses from the polarized light separating element to essentially the entire prescribed illumination area;
a reflective modulating element that is essentially of the same size as the prescribed illumination area, and is located on the prescribed illumination area and modulates the light from the illuminating device;
a polarizing plate that is located in the light path of the light modulated by the liquid crystal valve; and
a projecting optical system that projects the light that passes through the polarizing plate and causes it to form an image.

22. A projecting display device comprising:
an illuminating optical device having:
a light source that emits non-polarized light;
a parallelization converter that converts the light emitted from the light source into essentially parallel light rays;
a first lens array that comprises multiple lenses that converge the light rays that strike each of them from the parallelization converter;
a polarized light separating element having the configuration of a thin plate with flat top and bottom surfaces, that reflects a first polarized light component of the non-polarized light and transmits the remaining second polarized component, and is located in the light path of the light from the first lens array such that it is angled relative to the light path;
a reflection element that reflects the second polarized light component and the first polarized light component while converting them into a first polarized light component and a second polarized light component, respectively, and is located near and essentially parallel to the polarized light separating element, wherein the reflection element reflects the light from the first lens array that passed through the polarized light separating element so that it strikes the polarized light separating element, and the reflection element re-reflects the light reflected by the polarized light separating element so that the main light rays pass through the polarized light separating element between the points struck by the light from the first lens array;
a linear polarization converter that converts into uniform linearly polarized light the light from the first lens array that was reflected by the polarized light separating element and the light from the reflection element that passed through the polarized light separating element; and
a second lens array that comprises multiple lenses and is located near the light convergence points for the first lens array, and that leads the light rays that strike each of the multiple lenses from the polarized light separating element to essentially the entire prescribed illumination area;
a reflective modulating element that is essentially of the same size as the prescribed illumination area, and is located on the prescribed illumination area and modulates the light from the illuminating device;
a polarizing plate that is located in the light path of the light modulated by the liquid crystal valve; and
a projecting optical system that projects the light that passes through the polarizing plate and causes it to form an image.

23. A projecting display device comprising:
an illuminating optical device having:
a light source that emits non-polarized light;
a parallelization converter that converts the light emitted from the light source into essentially parallel light rays;
a polarized light separating element having the configuration of a thin plate with flat top and bottom surfaces, that reflects a first polarized light component of the non-polarized light and transmits the remaining second polarized component, and is located in the light path of the light from the parallelization converter such that it is angled relative to the light path;
a reflection element that reflects the second polarized light component while maintaining its state of polarization and is located near the polarized light separating element such that the former is slightly angled relative to the latter, wherein the reflection element reflects the light from the parallelization converter that passed through the polarized light separating element so that it passes through the polarized light separating element in a non-parallel fashion relative to the light from the parallelization converter that was reflected by the polarized light separating element;
a first lens array that comprises multiple lenses that converge the light rays that strike each of them from the polarized light separating element;
a linear polarization converter that converts into uniform linearly polarized light from the parallelization converter that was reflected by the polarized light separating element and passed through the first lens array and the light from the reflection element that passed through the polarized light separating element and the first lens array; and
a second lens array that comprises multiple lenses and is located near the light convergence points for the first lens array, and that leads the light rays that strike each of the multiple lenses from the first lens array to essentially the entire prescribed illumination area;
a reflective modulating element that is essentially of the same size as the prescribed illumination area, and that is located on the prescribed illumination area and modulates the light from the illuminating device;
a polarizing plate that is located in the light path of the light modulated by the liquid crystal valve; and
a projecting optical system that projects the light that passes through the polarizing plate and causes it to form an image.

24. A projecting display device comprising:
an illuminating optical device having:
a light source that emits non-polarized light;
a parallelization converter that converts the light emitted from the light source into essentially parallel light rays;
a polarized light separating element having the configuration of a thin plate with flat top and bottom surfaces, that reflects a first polarized light component of the non-polarized light and transmits the remaining second polarized component, and is located in the light path of the light from the parallelization converter such that it is angled relative to the light path;
a first reflection element that reflects the second polarized light component while converting it into a first polarized light component, and that reflects the light from the parallelization converter that passed through the polarized light separating element such that it strikes and becomes reflected by the polarized light separating element;
a second reflection element that reflects the first polarized light component while converting it into a second polarized light component and that reflects the light from the first reflection element that was reflected by the polarized light separating element, such that it passes through the polarized light separating element in a non-parallel fashion relative to the light from the parallelization converter that was reflected by the polarized light separating element;
a first lens array that comprises multiple lenses that converge the light rays that strike each of them from the polarized light separating element;
a linear polarization converter that converts into uniform linearly polarized light the light from the parallelization converter that was reflected by the polarized light separating element and passed through the first lens array and the light from the second reflection element that passed through the polarized light separating element and the first lens array; and
a second lens array that comprises multiple lenses and is located near the light convergence points for the first lens array, and that leads the light rays that strike each of the multiple lenses from the first lens array to essentially the entire prescribed illumination area;
a reflective modulating element that is essentially of the same size as the prescribed illumination area, and is located on the prescribed illumination area and modulates the light from the illuminating device;
a polarizing plate that is located in the light path of the light modulated by the liquid crystal valve; and
a projecting optical system that projects the light that passes through the polarizing plate and causes it to form an image.
